(19) United States
(12) Patent Application Publication
(10) Pub. No.: US 2010/0059453 A1
(43) Pub. Date: Mar. 11, 2010

(54) SYSTEM AND METHOD FOR DE-WATERING WASTE DRILLING FLUIDS

(75) Inventors: David B. REARDON, Houston, TX (US); Dilipkumar P. SHAH, Sugar Land, TX (US)

Correspondence Address: CONLEY ROSE, P.C.;David A. Rose, P. O. BOX 3267, HOUSTON, TX, 77253-3267, US

(73) Assignee: KEM-TRON TECHNOLOGIES, INC., Stafford, TX (US)

(21) Appl. No.: 12/555,900

(22) Filed: Sep. 9, 2009

Related U.S. Application Data
(60) Provisional application No. 61/095,532, filed on Sep. 9, 2008.

(51) Int. Cl. C02F 1/52

(52) U.S. Cl. 210/727; 210/202; 210/734

(57) ABSTRACT

Systems and methods for de-watering waste drilling fluid. In some embodiments, the de-watering system includes a drilling fluid reclamation system receiving the waste drilling fluid from a wellbore and removing at least some solids from the waste drilling fluid, a manifold combining the waste drilling fluid from the drilling fluid reclamation system and organic polymers, whereby an aggregated mixture of solids in the waste drilling fluid and water are formed, and a centrifuge receiving the aggregated mixture and separating the solids from the water in the aggregated mixture, whereby solid drilling fluid waste and substantially colloidal-free water are formed.

### CROSS-REFERENCE TO RELATED APPLICATIONS

This application claims benefit of U.S. provisional application Ser. No. 61/095,532 filed on Sep. 9, 2008, and entitled “System and Method for De-Watering Waste Drilling Fluids,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to systems and methods for de-watering drilling fluid. More particularly, the present disclosure relates to systems and methods for de-watering waste drilling fluid by conditioning the fluid with organic polymers.

A key element of any drilling process is the use of drilling fluid, or mud. The drilling fluid serves several purposes. The density, or weight, of the drilling fluid prevents formation fluids and gases from entering the wellbore, and thus controls formation pressures. The drilling fluid also suspends and carries drilled cuttings from the bottom of the wellbore to the surface. Solids control equipment at the surface enable the drilling fluid to re-circulated continuously, and/or deposited into earthen pits, also called reserve pits, located adjacent drilling rig mud tanks.

Prior to drilling a well, the drilling operator was required to construct and line a reserve pit to contain the amount of drilled cuttings and thousands of barrels of water-based drilling fluid waste expected to be generated from solids control equipment discharge and dumping of drilling fluid waste to maintain optimum fluid properties, cement displacement, and rig tank cleaning prior to rig moves. Since most of the drilling rigs using traditional practices did not utilize specific types and efficient solids control equipment, it was common that a “dump and dilute” approach was followed to control mud density, viscosity, and solids content to help improve bit penetration rates and prevent drill pipe sticking tendencies. The “dump and dilute” approach meant that large volumes of water would be consumed to reduce the concentration of colloidal solids and reformulated with chemical additives to bring the optimum drilling fluid properties back in line. Meanwhile, the reserve pit continued to contain greater volumes of drilling fluid waste as a result of the periodic dumping. The traditional drilling operation has been phased out as a result of governmental regulatory agencies, citizens, rig locations, drilling costs, well complexity, and drilling fluid performance.

In order to provide bit lubrication and cooling, cuttings removal and well control, the properties of drilling fluid must be carefully controlled. As cuttings build up in drilling fluid, the weight and viscosity of the drilling fluid increases, which in turn, increases drag forces on the drill bit slowing the rate of penetration (ROP), increases the thickness of wall cake on the borehole wall, and makes control of the well pressure more difficult. To control the drilling fluid weight and viscosity, and thus prevent loss of well control, reduced ROP, and/or a drilling component from becoming stuck in the borehole due to increased wall cake thickness, water is added to the reclaimed drilling fluid to condition it prior to re-injection.

To reduce the costs associated with disposing waste drilling fluid, transporting clean water to the well site, and site restoration, a variety of techniques have been developed for de-watering waste drilling fluid. These de-watering techniques enable water to be reclaimed from waste drilling fluid and subsequently combined with unused or recycled drilling fluid prior to injection into the drill string. After water is separated from waste drilling fluid, the remaining solid waste is smaller in volume and lighter in weight, as compared to that of the waste drilling fluid prior to de-watering, and can be transported from the well site and disposed of at significantly less expense.

The conventional means of solids control equipment used on a drilling rig begins as drilling fluid exits the borehole at the flow line. The drilling fluid passes through a linear motion shaker capable of handling 100% of the mud pump flow while removing coarse sized solid particles between 320 to 75 microns, depending upon the screen mesh size being used. The drilling fluid then passes through de-sander and de-silter hydrocylclones for further removal of fine and silt sized drill solid particles ranging in size between 20 to 74 micron at a process rate of approximately 110% of the mud pump flow rate. Finally, the fluids are processed by a high speed solids control decanter centrifuge to remove ultra-fine drill solid particles greater than 5 micron at an average process rate of approximately 20% of the mud pump flow rate.

Studies have shown that the colloidal content a water base drilling fluid, the faster the drill bit rate of penertion. Minimizing colloidal solids help lower the plastic viscosity of drilling fluid, contributing to greater horsepower at the bit. However, removing colloidal solids becomes difficult if not impossible, if they are allowed to accumulate and further degrade when continuously re-circulated in the drilling fluid. Colloidal solids with particle sizes greater than 5 micron and larger are removed from the drilling fluid waste by particle charge destabilization with a high cationic charged/low molecular weight organic polymer and aggregated together to form a “Hard Floc” with the addition of a varying anionic charged/high molecular with organic polymer.

To further increase the overall efficiency of these conventional de-watering processes, inorganic polyelectrolytes or polymers are often added to the drilling fluid prior to entering the centrifuge. Drilling fluid is a suspension of various sized solids generated from the ground or commercially produced, and water. The solid particles carry an electrical charge that causes them to repel one another, thereby enabling the solids to be suspended in the water. Due to these repulsive forces and the concentration of colloidal/ultra-fine solids, the drilling fluid would require such a significant amount of time as to make this natural process an impractical means of de-watering. To accelerate the de-watering process, the drilling fluid is treated with inorganic coagulant prior to conveying the drilling fluid through the centrifuge. Typically, an inorganic coagulant, such as aluminum sulfate, polyaluminum chloride, ferric chloride, calcium hydroxide, or acid, is first added to the drilling fluid to de-stabilize the suspended solids of the mixture. As used herein, de-stabilization refers to the process of neutralizing the electrical charge of solids suspended in the colloidal mixture, or drilling fluid, so as to reduce or breakdown their repulsive forces.

After de-stabilization of the solids, an organic flocculant is added to the drilling fluid to aggregate the de-stabilized solids so that when the drilling fluid passes through the centrifuge, the de-stabilized and subsequently aggregated solids do not break apart and cause the centrate, or reclaimed water, to become highly turbid and discharge wet cake solids. The organic flocculant has an electrical charge that attracts the de-stabilized solids, causing the solids to attach themselves to the flocculant. Attachment of the de-stabilized solids to the organic flocculant forms an aggregated network of de-stabilized solids called flocs. By de-stabilizing and subsequently aggregating the solids into flocs, the solids and water of the colloidal mixture, or drilling fluid, may be more easily and effectively separated in the centrifuge, thereby increasing the overall efficiency of the de-watering process.

Inorganic coagulants are used in conventional de-watering techniques primarily because these substances are by-products, or waste, produced by other common chemical processes, and thus are relatively inexpensive. Even so, their use is not without disadvantages. First, some inorganic coagulants, such as acid, are ineffective de-stabilizers. When used as the sole de-stabilizing coagulant, the de-watering process yields water that still contains a significant level of colloidal solids. Second, inorganic coagulants will not react with suspended solids in a colloidal mixture if the pH level of that mixture is too high. Drilling fluid, such as mud, typically has a high pH level. Therefore, in order to de-stabilize drilling fluid using an inorganic coagulant, the drilling fluid must first be treated with acid to lower the pH level of the mixture to a range where the inorganic coagulant, when added to the treated mixture, reacts with the suspended solids in the mixture. The addition of acid in this manner increases the overall expense of the de-watering process. Third, the addition of inorganic coagulants to a colloidal mixture, like drilling fluid, causes the creation of solids within the mixture that are difficult to filter, de-water and are often corrosive. Further, the use of inorganic coagulants introduces chlorides to the water contained in the drilling fluid. This requires the treatment of that water with additives, such as sodium hydroxide, to adjust the pH level of the water prior to re-use. Finally, inorganic coagulants added with organic flocculants produce a small to medium sized aggregated de-stabilized solids, or flocs, that are fragile and sensitive to shear rate and may break apart within the centrifuge and become again suspended in the colloidal mixture. To prevent this, it may be necessary to reduce the feed rate to the centrifuge, which in turn, slows the de-watering production rate.

Embodiments of the present disclosure are directed to de-watering systems and methods that seek to overcome these and other limitations of the prior art.

### SUMMARY OF THE PREFERRED EMBODIMENTS

Systems and methods for de-watering waste drilling fluid. In some embodiments, the de-watering system includes a drilling fluid reclamation system receiving the waste drilling fluid from a wellbore and removing at least some solids from the waste drilling fluid, a manifold combining the waste drilling fluid from the drilling fluid reclamation system and organic polymers, whereby an aggregated mixture of solids in the waste drilling fluid and water are formed, and a centrifuge receiving the aggregated mixture and separating the solids from the water in the aggregated mixture, whereby solid drilling fluid waste and substantially colloidal-free water are formed.

In some embodiments, the de-watering system includes a manifold with a de-stabilizing zone and an aggregating zone downstream of the de-stabilizing zone. The de-stabilizing zone is adapted to combine organic coagulant and the waste drilling fluid, whereby solids suspended in the waste drilling fluid are de-stabilized and a de-stabilized mixture of the de-stabilized solids is formed. The aggregating zone is adapted to combine organic flocculant and the de-stabilized mixture, whereby the de-stabilized solids are aggregated to form a plurality of flocs and an aggregated mixture of the flocs and water is formed.

Some methods for de-watering waste drilling fluid flowing at a preselected flowrate include rotating a sample of the waste drilling fluid in a container to form a vortex, adding a quantity of organic coagulant to the sample until coagulation of the sample occurs, wherein solids contained in the sample are de-stabilized, adding a quantity of organic flocculant to the sample until aggregation occurs, wherein a plurality of flocs are formed, calculating a flowrate of the coagulant as a function of the quantity of the coagulant added to the container, the quantity of the waste drilling fluid added to the container, and the preselected waste drilling fluid flowrate, and calculating a flowrate of the flocculant as a function of the quantity of the flocculant added to the container, the quantity of the waste drilling fluid added to the container, and the preselected waste drilling fluid flowrate.

Thus, the embodiments of the invention comprise a combination of features and advantages that enable substantial enhancement of couplings. These and various other characteristics and advantages of the invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a schematic representation of a de-watering system in accordance with the principles disclosed herein;

FIG. 2 is a schematic representation of the de-stabilizing and flocculating manifold of FIG. 1;

FIG. 3 is a method for quantifying the optimum volumetric flowrates of organic coagulant and organic flocculant to be added during de-watering of waste drilling fluid;

FIG. 4 depicts an embodiment of a human-machine interface (HMI);

FIG. 5 depicts the control module for drilling fluid flow within the HMI of FIG. 4;

FIG. 6 depicts the control module for acid flow within the HMI of FIG. 4;

FIG. 7 depicts the control module for organic coagulant flow within the HMI of FIG. 4; and

FIG. 8 depicts the control module for organic flocculant flow within the HMI of FIG. 4.

### NOTATION AND NOMENCLATURE

Certain terms are used throughout the following description and claims to refer to particular system components. This document does not intend to distinguish between components that differ in name but not function. Moreover, the drawing figures are not necessarily to scale. Certain features of the invention may be shown exaggerated in scale or in somewhat schematic form, and some details of conventional elements may not be shown in the interest of clarity and conciseness.

In the following discussion and in the claims, the term “comprises” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION OF THE PREFERRED EMBODIMENTS

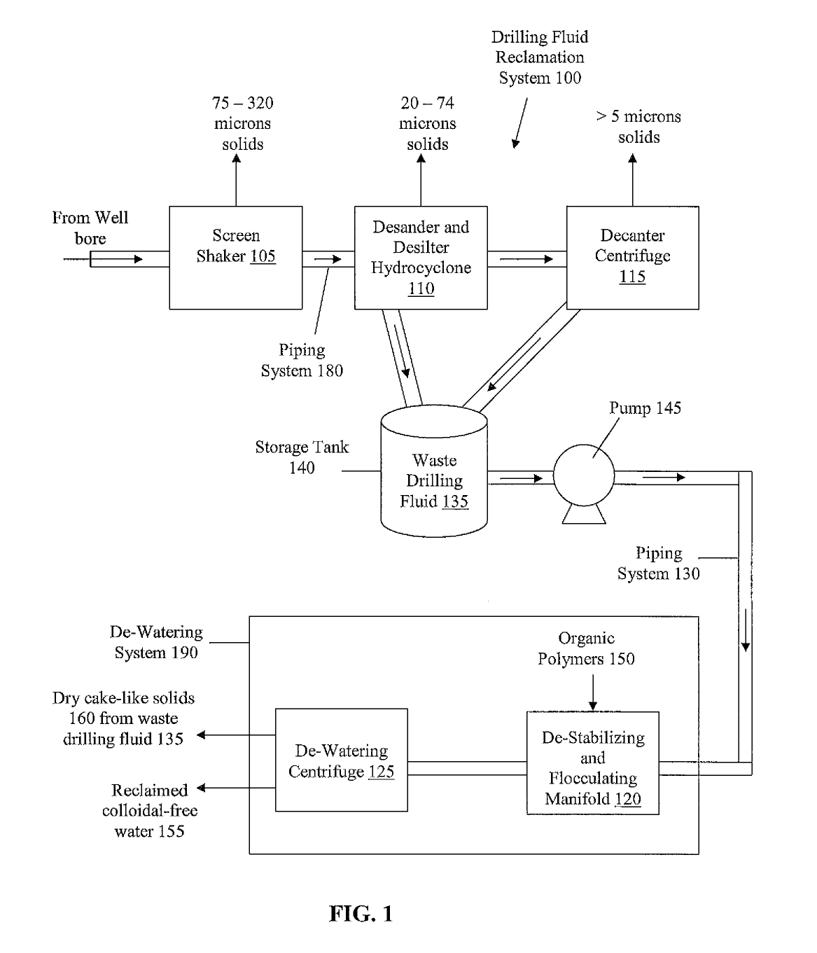

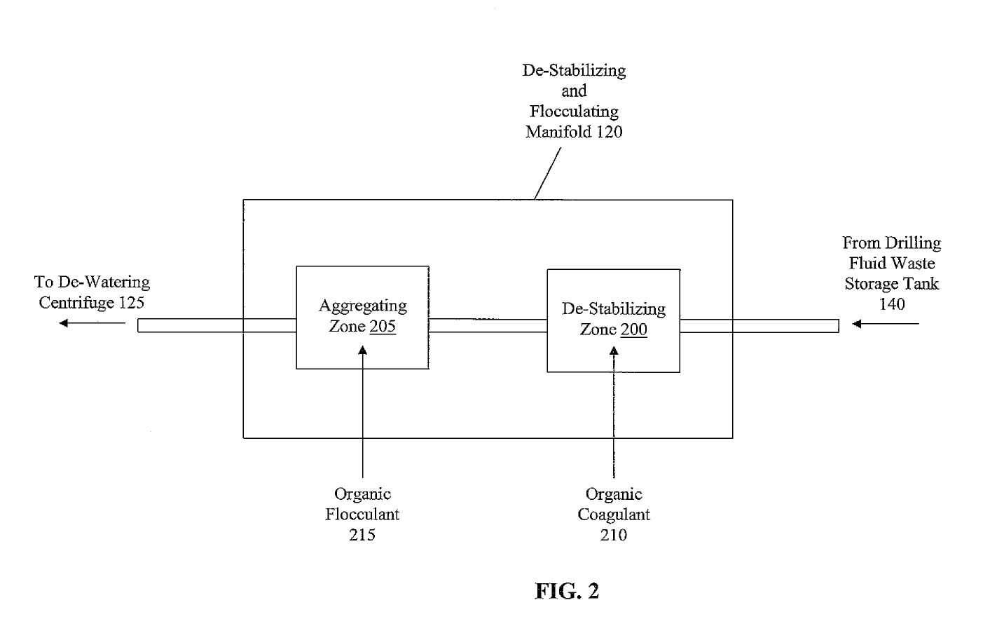

Referring now to FIG. 1, a schematic representation of a drilling fluid reclamation system and a de-watering system in accordance with the principles disclosed herein is shown. Drilling fluid reclamation system 100 includes a screen shaker 105, a desander and desilter hydrocyclone 110, and a decanter centrifuge 115 coupled by a piping system 180. Waste drilling fluid 135 reclaimed from a well bore at a well site is conveyed through piping system 180 to screen shaker 105 and the components of reclamation system 100 downstream of screen shaker 105. Upon exiting reclamation system 100, waste drilling fluid 135 is stored in a waste drilling fluid storage tank 140. In some embodiments of reclamation system 100, excess drilling fluid may also be conveyed to and stored in tank 140.

Each of screen shaker 105, hydrocyclone 110, and decanter centrifuge 115 is configured to remove solid particles within a prescribed size range from waste drilling fluid 135 as waste drilling fluid 135 passes therethrough. In this exemplary embodiment, screen shaker 105 removes solids having dimensions in the range 75 to 320 microns. Hydrocyclone 110 removes relatively smaller solids having dimensions in the range 20 to 74 microns. Decanter centrifuge 115 removes particulates having dimensions greater than 5 microns, while high-speed centrifuge 125 removes smaller particulates. Thus, as waste drilling fluid 135 passes through each of these respective devices 105, 110, 115, more solids are progressively removed from waste drilling fluid 135, thereby decreasing the concentration of solids suspended in drilling fluid 135.

De-watering system 190 includes a de-stabilizing and flocculating manifold 120 and a de-watering centrifuge 125, both connected in series by a piping system 130. Reclaimed waste drilling fluid 135, contained in a storage tank 140, is conveyed by a pump 145 through piping system 130 to manifold 120 and de-watering centrifuge 125. In this exemplary embodiment, pump 145 is a progressive cavity feed pump. However, in other embodiments, pump 145 may be another equivalent type of pump known in the industry.

De-watering centrifuge 125 applies centrifugal force to waste fluid drilling 135 passing therethrough. The centrifugal force creates a pressure load exerted on waste drilling fluid 135 causing water contained therein to be forced from waste solids also contained in drilling fluid 135. In some embodiments, de-watering centrifuge 125 removes particulates having dimensions less than 5 microns. To promote the ease and effectiveness at which high-speed de-watering centrifuge 125 removes particulates from waste drilling fluid 135 passing therethrough, waste drilling fluid 135 is treated or conditioned within coagulation and flocculation manifold 120 with organic polymers 150 prior to entering de-watering centrifuge 125.

Turning now to FIG. 2, manifold 120 includes a de-stabilizing zone 200 and an aggregating zone 205. Waste drilling fluid 135 is conveyed via pump 145 from drilling waste storage tank 140 first into de-stabilizing zone 200 of manifold 120. Within de-stabilizing zone 200, an organic coagulant 210 is introduced to waste drilling fluid 130 to de-stabilize solids remaining suspended in waste drilling fluid 135 and to subsequently form bridges between the de-stabilized solids to form a colloidal web. The colloidal web is an essential building block for developing a hard floc that maintains retention, i.e., does not break apart, regardless of shear stress and shear rate experienced when passing through manifold 120 and de-watering centrifuge 125.

Organic coagulant 210 has an electrical charge that acts to neutralize the electrical charge of solids suspended in the drilling fluid 135 and a low molecular weight. In some embodiments, organic coagulant 210 is cationic and has a molecular weight in the range 1000 to 1 million. The positive charge of organic coagulant 210 neutralizes the electrical charge of solids suspended in the drilling fluid, and thus reduces or breaks down their repulsive forces relative to each other. In other words, organic coagulant 210 de-stabilizes the solids in the drilling fluid. The low molecular weight of organic coagulant 210 enables faster de-stabilization of the solids and a lower viscosity of the water remaining in waste drilling fluid 135, as compared to that provided by the conventional use of inorganic coagulants. Organic coagulant 210 may be in powder, emulsion or liquid form, and in some embodiments, is a polyamide coagulant, such as “Color-Katch-7” manufactured by Kem-Tron, Inc.

Due to the organic nature of coagulant 210, waste drilling fluid 135 need not be pre-treated, for example, with acid to lower its pH level prior to introduction into de-stabilizing zone 200. Unlike inorganic coagulants, organic coagulant 210 reacts with solids suspended in a high pH fluid. Thus, organic coagulant 210 is an effective de-stabilizer of high pH fluids, like waste drilling fluid 135, and need not be pre-treated to enable a reaction of organic coagulant 210 with solids in drilling fluid 135. Also in contrast to inorganic coagulants, after de-stabilizing solids in drilling fluid 135, organic coagulant 210 promotes the formation of a network of meshed, de-stabilized solids which is more easily separated from water remaining in drilling fluid 135 during processing in de-watering centrifuge 125. The ability of organic coagulant 210 to promote the formation of such a colloidal web of de-stabilized solids increases the overall efficiency of de-watering system 190.

After the solids remaining in waste drilling fluid 135 are de-stabilized, drilling fluid 135 passes from de-stabilizing zone 200 into aggregating zone 205 of manifold 120. Within aggregating zone 205, an organic flocculant 215 is introduced to waste drilling fluid 135 to aggregate the de-stabilized solids contained therein to form a plurality of large, rounded flocs. Aggregating the de-stabilized solids enables the solids to withstand shear forces imparted to them during processing in high-speed centrifuge 125 without breaking the solids apart and causing the solids to become again dispersed or suspended in the water of waste drilling fluid 135.

Organic flocculant 215 has an electrical charge that attracts the de-stabilized solids within drilling fluid 135 and a high molecular weight. The electrical charge of organic flocculant 215 causes the de-stabilized solids to attach themselves to organic flocculant 215, thereby creating large, rounded flocs of aggregated de-stabilized solids. The high molecular weight of organic flocculant 215 allows the large, rounded flocs of de-stabilized solids to withstand shear forces imparted to the flocs during processing by high-speed centrifuge 125. In some embodiments, organic flocculant 215 has a molecular weight in the range 13 million to 15 million. Further, the organic nature of flocculant 215 enables larger, harder and more rounded flocs of de-stabilized solids, as compared to smaller, rougher flocs achievable with the use of conventional inorganic flocculants. By increasing the floc size, the flocs are more resistive to shear forces and thus less likely to break apart in high-speed centrifuge 125. As such, there is less of a need to slow the speed of centrifuge 125 to ensure the flocs remain intact during processing in centrifuge 125. Further, the rounded configuration of the flocs promote re-aggregation of the solids should some of them break apart in centrifuge 125. Thus, the larger, more rounded flocs promote the overall efficiency and production rate of de-watering system 190.

Organic flocculant 215 may be in powder, emulsion or liquid form, and in some embodiments, is a polyacrylamide flocculant, such as “K-Floc,” “Kan-Floc,” or “Kat-Floc” manufactured by Kem-Tron, Inc. Additionally, in some embodiments, organic flocculant 215 is a blended polyacrylamide flocculant, which includes a quantity of flocculant, e.g., “Kan-Floc”, having a particular charge density mixed with another quantity of the same flocculant but having a different charge density. For example, organic flocculant 215 may include an equal blend, by volume, of Kan-Floc having a charge density of 2% and Kan-Floc having a charge density of 23%. As used herein, charge density refers to the percentage of sites along a polymer chain given an electrical charge. For instance, 2% charge density means that 2% of the sites along a polymer chain are given a negative or anionic electrical charge, while the remaining 98% of the sites have no electrical charge. Testing has indicated that a blended polyacrylamide flocculant is more effective than an unblended polyacrylamide flocculant having a charge density approximately equal to an average of the two charge densities included in the blend. In other words, and continuing with the example above, a blended polyacrylamide flocculant having equal amounts by volume of 2% charge density Kan-Floc and 23% charge density Kan-Floc is more effective than the same volume of 14% charge density Kan-Floc.

After aggregation of the de-stabilized solids remaining in waste drilling fluid 135, drilling fluid 135 passes from aggregating zone 205 into de-watering centrifuge 125, where, as described above and illustrated in FIG. 1, the water remaining in drilling fluid 135 is forced from the flocs of de-stabilized solids in fluid 135 under pressure from centrifugal force applied to fluid 135. Upon completion of processing in high-speed centrifuge 125, two products exit centrifuge 125: a colloidal-free or clear water 155, which may be re-used, for example, to condition drilling fluid prior to injection downhole, and a cake-like solids 160, which may be transported from the well site for disposal.

The de-watering systems and methods disclosed herein, including de-watering system 190, enable the production of colloidal-free or clear water 155 at faster production rates than possible with conventional systems and methods. Further, the use of an organic coagulant in the de-watering process yields colloidal-free or clear water that may be reused without the need to treat it, such as to alter its pH, prior to reuse. In other words, the use of organic coagulant 210 does not alter the pH level of water in waste drilling fluid 130 such that, once separated from the solids suspended in fluid 130, the water requires treatment or conditioning prior to reuse. This is in contrast to conventional de-watering systems and associated methods utilizing inorganic coagulants that produce water having higher levels of colloidal solids. Such “grey water” often must be treated to lower its pH prior to reuse, a practice that increases drilling time and expense. Furthermore, cake-like solids 160 produced by de-watering systems and methods disclosed herein, including de-watering system 190, have lower water content than that produced by conventional de-watering systems and methods. By reducing the water content, solids 160 are lighter by weight and occupy less volume that they would otherwise, allowing them to be transported from the well site and disposed of at lower cost, comparatively speaking.

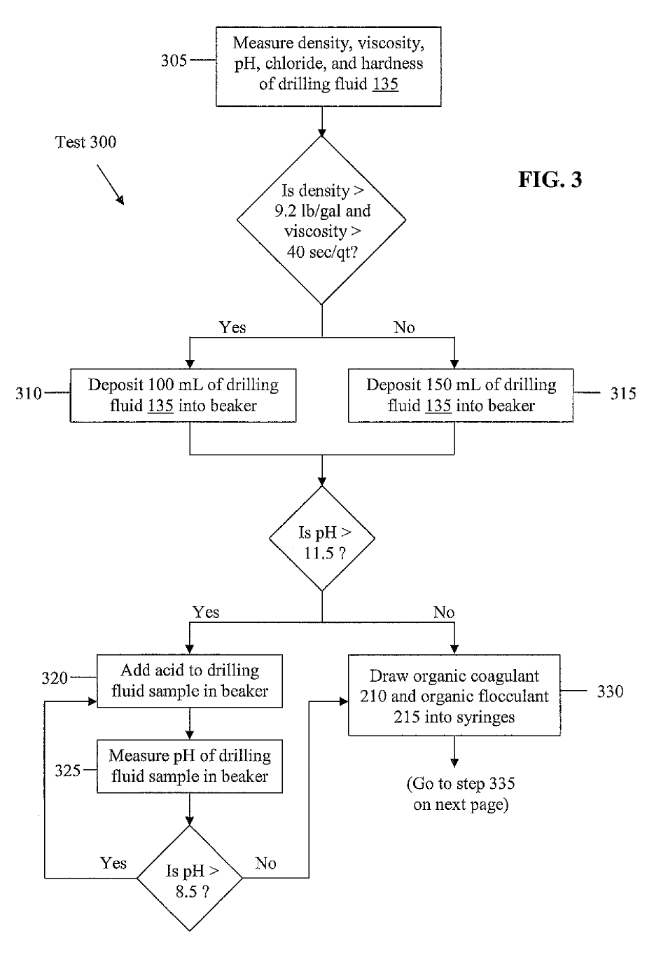

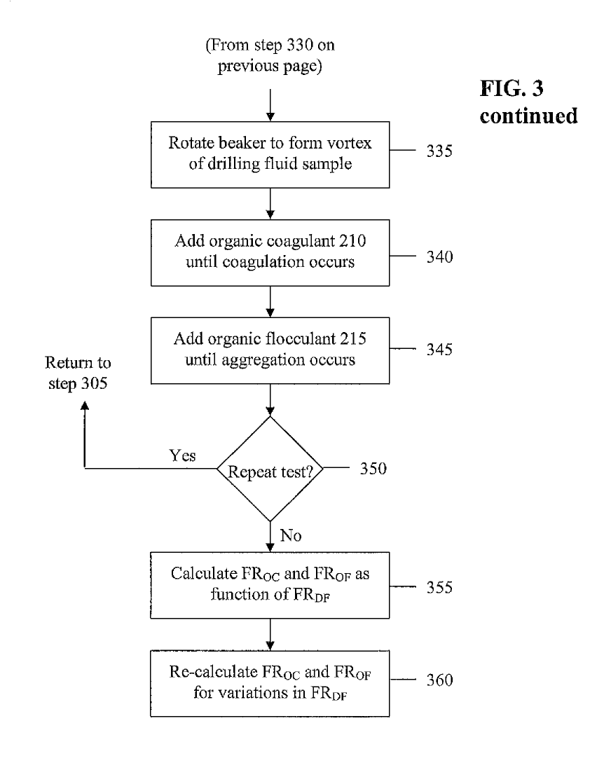

While the use of organic polymers in de-watering of waste drilling fluid 135 offers the improvements and benefits described above, the de-watering methods disclosed herein may be further improved, even optimized, by careful control of the relative quantities of organic coagulant 210 and organic flocculant 215 introduced during de-watering. Turning to FIG. 3, a method of quantifying the optimum volumetric flow rates of organic coagulant 210 and organic flocculant 215 required to de-water a given volumetric flow rate of waste drilling fluid 135 is depicted. This method 300, referred to herein as “the Reardon Vortex Beaker Test” or simply “the Test,” enables optimization of de-watering system 190 and related methods illustrated by FIGS. 1 and 2.

Test 300 begins by measuring the density in lbs/gallon, viscosity in sec/qt, pH, chloride level, and hardness of a well-mixed quantity of drilling fluid 135 for which de-watering is desired (step 305). If the measured density exceeds 9.2 lb/gal and the measured viscosity exceeds 40 sec/qt, a 100 mL sample of well-mixed drilling fluid 135 is deposited into a container, such as but not limited to a beaker (step 310). In some embodiments, the volume of the beaker is 400 mL. Alternatively, if the measured density is less than 9.2 lb/gal or the measured viscosity is less than 40 sec/qt, a 150 mL sample of well-mixed drilling fluid 135 is deposited into the beaker (step 315).

For reasons presented below, the volume in mL of drilling fluid 135 added to the beaker in either step 310 or step 315 is identified symbolically herein as V_{DF}.

Depending on the pH level measured in step 305, the drilling fluid sample may require acid treatment to adjust its pH. If the measured pH level exceeds 11.5, a small quantity of acid is added to the drilling fluid sample deposited in the beaker (step 320). The drilling fluid sample is then stirred and its pH level measured using a pH meter (step 325). This process, meaning steps 320 and 325, are repeated until the pH level of the drilling fluid sample is approximately 8.5.

Next, a first quantity of organic coagulant 210 and a second quantity of organic flocculant 215 are drawn into a first syringe and a second syringe, respectively (step 330). In some embodiments, these quantities are 3 cc and 10 cc, respectively. If the chloride and hardness levels, both measured in step 320, exceed 2500 ppm and 400 mg/L, respectively, a high molecular weight organic flocculant 215 should be selected for step 330 and all subsequent steps. As the organic polymers are drawn into their respective syringes, any air that becomes entrapped in either syringe is forced from the affected syringe before drawing additional polymer therein.

The beaker, with the drilling fluid sample contained therein, is then rotated to cause the drilling fluid sample to form a vortex within the beaker (step 335). As the beaker is rotated in this manner, organic coagulant 210 contained in the first syringe is gradually added to the drilling fluid sample contained in the beaker (step 340). Once the drilling fluid sample slightly thickens, indicating coagulation of the drilling fluid sample, the addition of organic coagulant 210 ceases, and the total volume in milliliters (cubic centimeters) of organic coagulant 210 added to the beaker, V_{OC}, is recorded. The vortex formed by rotation of the beaker promotes the ability to see coagulation of the drilling fluid sample contained in the beaker.

As rotation of the beaker continues, organic flocculant 215 contained in the second syringe is slowly added to the now-coagulated drilling fluid sample contained in the beaker (step 345). When large, smooth flocs of drilling fluid form, each approximately ⅜″ to ¾″ in diameter and having the ability to slide around the beaker without breaking apart, the addition of organic flocculant 215 ceases, and the total volume in cc's of organic flocculant 215 added to the beaker, V_{OF}, is recorded. At this point in test 300, the beaker contains large, smooth flocs of aggregated, de-stabilized drilling fluid solids substantially separated from water also contained therein.

If the size and strength of flocs and/or water clarity obtained in step 345 are not as desired, or more organic flocculant 215 is added in step 345 than desired, steps 305 through 345 should be repeated. During repeat of steps 305 through 345, a different amount, either more or less, of organic coagulant 210 should be added at step 340. Steps 305 through 345 may repeated until the desired size and strength of flocs and water clarity is obtained (step 350).

Upon satisfactory completion of steps 305 through 345, the optimum volumetric ratios of organic coagulant 210 and organic flocculant 215 have been identified for the given sample of drilling fluid 135. These ratios may be determined from the volumes of organic coagulant 210, organic flocculant 215, and drilling fluid 135 required to satisfactorily complete steps 305 through 350. Next, this information is converted into volumetric flowrates indicating the rate at which organic coagulant 210 and organic flocculant 215 should be added to a specified volumetric flowrate of drilling fluid 135 during de-watering of fluid 135 to provide optimum production of colloidal-free or clear water 155 (FIG. 1) and solid drilling fluid waste 160 (FIG. 1).

For a specified volumetric flowrate of drilling fluid 135 in gal/min, FR_{DF}, pumped through a de-watering system, such as de-watering system 190 (FIG. 1), organic coagulant 210 and organic flocculant 215 should be added to drilling fluid 135, such as in de-stabilizing zone 200 (FIG. 2) and aggregating zone 205 (also FIG. 2), at volumetric flowrates, FR_{OC}, and FR_{OF}, respectively, as follows (step 355):

### Standard De-watering without Emulsion Polymer Make-down Units

FR_{OC}=V_{OC}/V_{DR}*FR_{DR}

FR_{OF}=V_{OF}/V_{DR}*2.5*FR_{DR}

### Standard De-watering with Emulsion and Liquid Polymer Make-down Units

FR_{OC}=V_{OC}/V_{DR}*FR_{DR}

FR_{OF}=V_{OF}/V_{DR}*2.0*FR_{DR}

Should the volumetric flowrate of drilling fluid 135, FR_{DF}, through the de-watering system change, or may be expected to change, the volumetric flowrates of organic coagulant 210, FR_{OC}, and of organic flocculant, FR_{OF}, should be adjusted in accordance with the above equations to continue to provide optimum de-watering of drilling fluid 135 (step 360).

While the Reardon Vortex Beaker Test is described above in the context of quantifying optimum organic coagulant 210 and organic flocculant 215 flowrates for a defined flowrate of waste drilling fluid 135, the Test may also be used to determine similar information regarding inorganic coagulants, inorganic flocculants, and/or other additives which may be introduced during de-watering of waste drilling fluid 135. In other words, the Test applies to organic as well as inorganic de-watering additives.

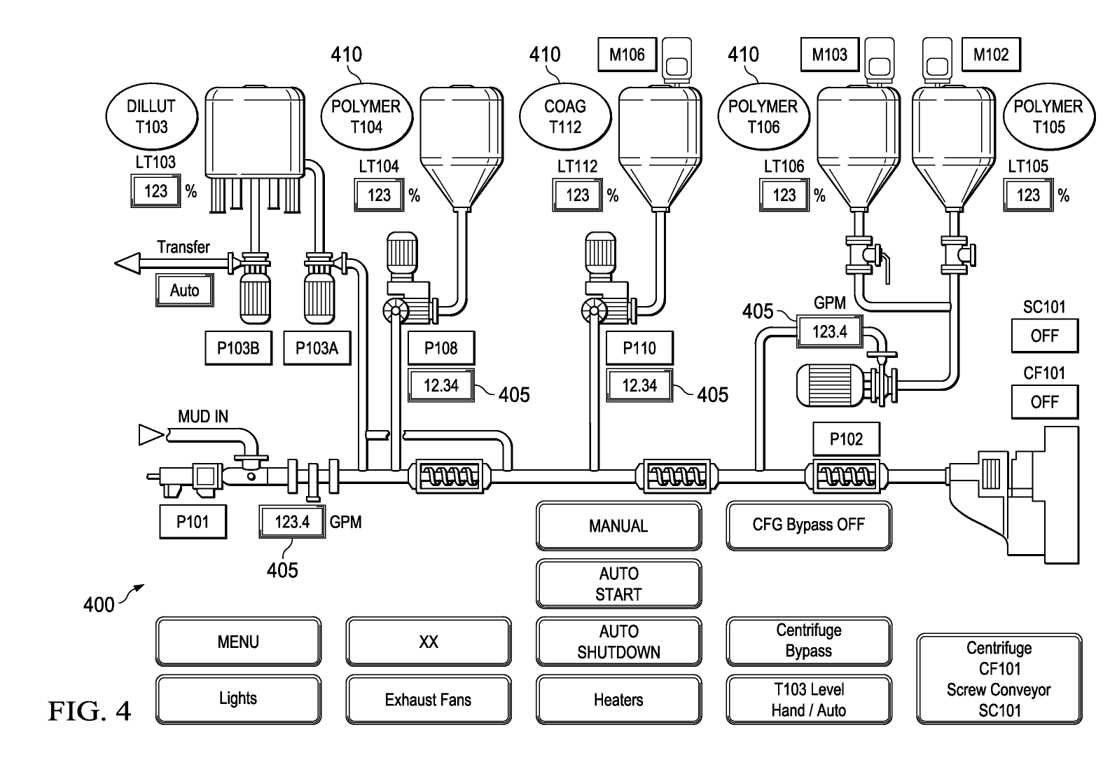

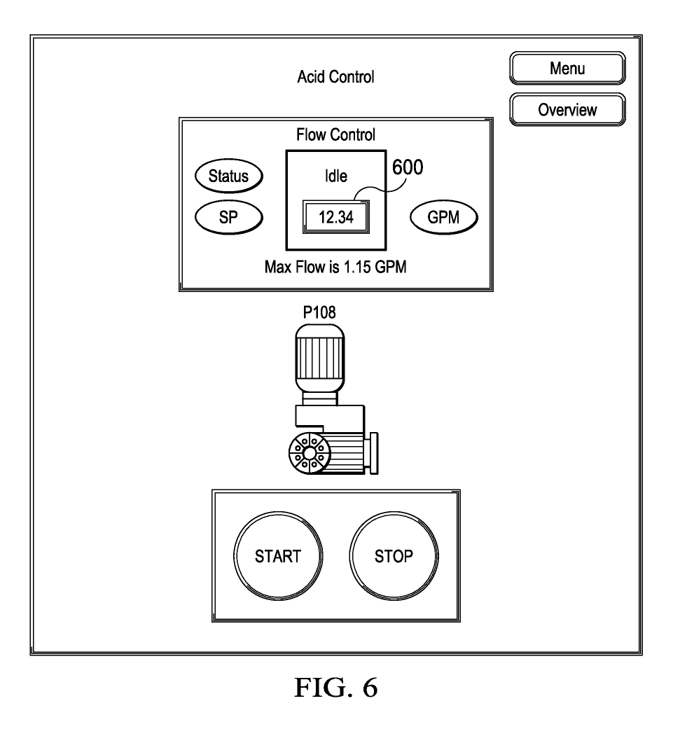

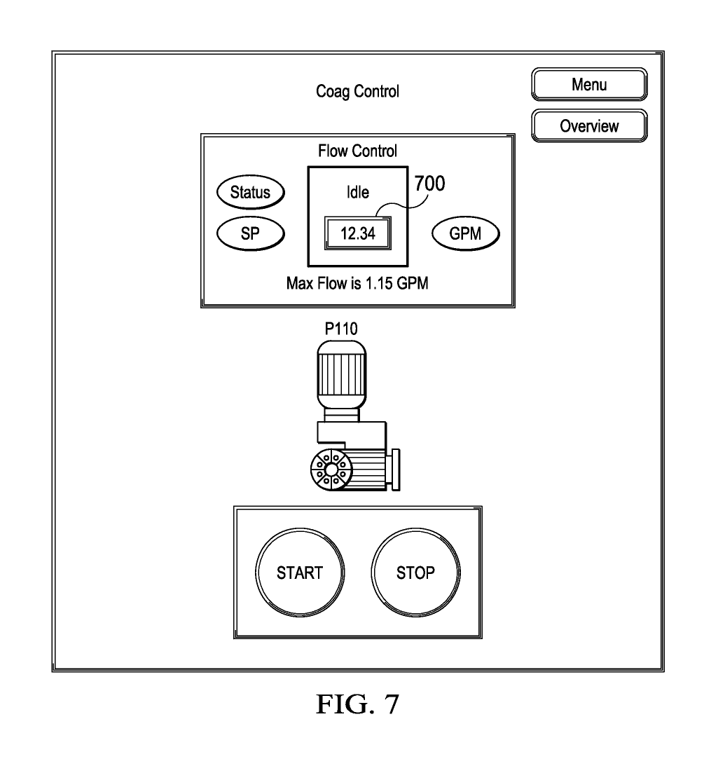

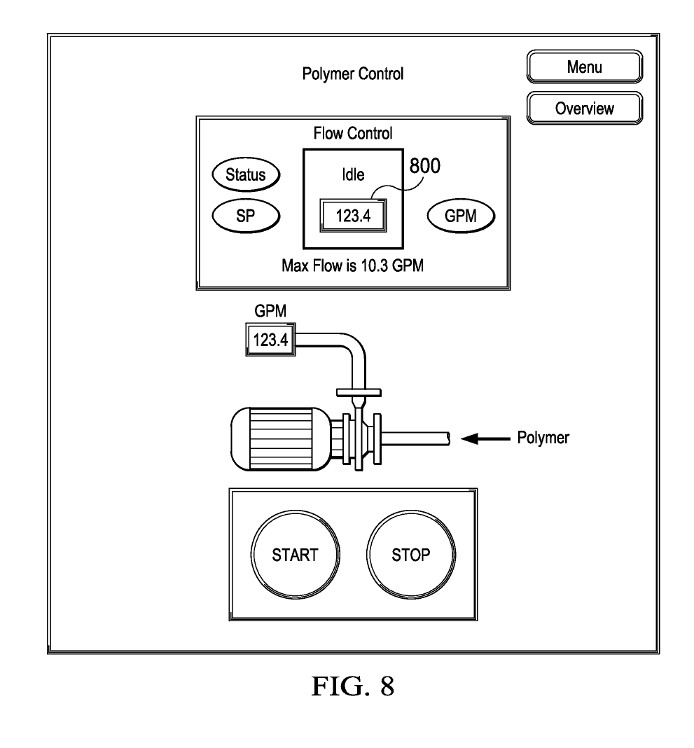

Adjustment of the volumetric flowrates of organic coagulant 210, FR_{OC}, and organic flocculant 215, FR_{OF}, as well as other parameters of a de-watering system, like de-watering system 190 (FIG. 1), may be achieved by the use of an interface configured to receive input from a human operator and generate a signal(s) which adjusts components of the de-watering system in accordance with the input. FIGS. 4 through 8 depict a human-machine interface (HMI) which is operable to define, control and adjust the volumetric flowrates of drilling fluid 135, FR_{DR}, organic coagulant 210, FR_{OC}, and organic flocculant 215, FR_{OF}, introduced to a de-watering system, as well as other parameters.

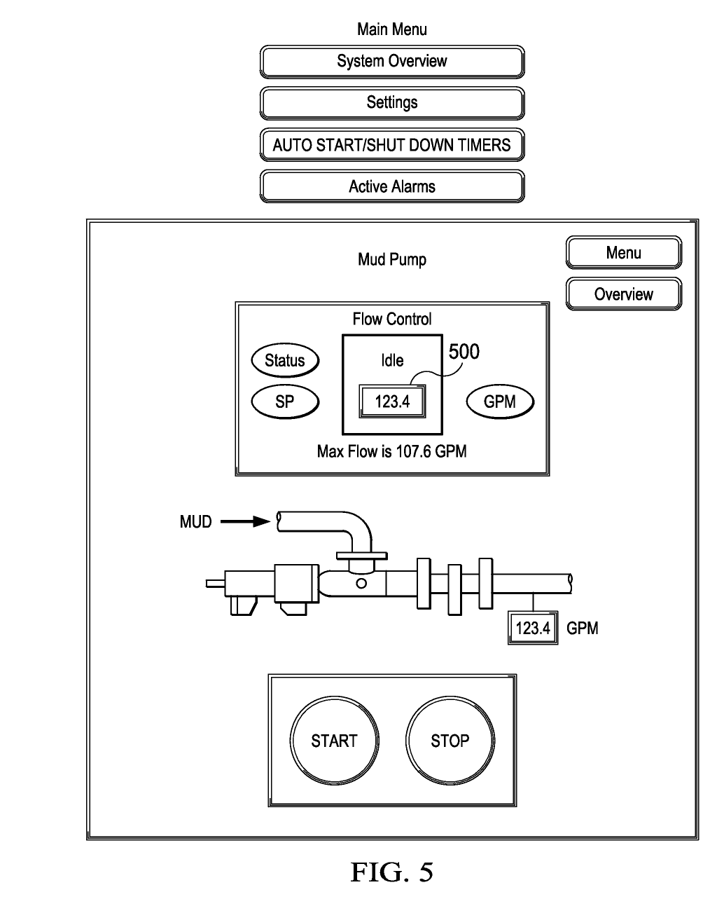

Turning to FIG. 4, HMI 400 is a computerized interface that allows a human operator to input desired flowrates 405 and other parameters affecting a de-watering process via a computer monitor having a touchsensitive display. The input is then converted into signal(s) which modify the affected subsystem(s) 410. In this exemplary embodiment, HMI 400 enables control of the volumetric flowrates 500, 600, 700, 800 of drilling fluid 135, FR_{DR}, acid, organic coagulant 210, FR_{OC}, and/or organic flocculant 215, FR_{OF}, respectively, through the de-watering system, as illustrated by FIGS. 5, 6, 7 and 8, respectively. A human operator may adjust these flowrates 500, 600, 700, 800 as needed during de-watering. In some embodiments, his or her adjustments are in accordance with the Reardon Beaker Test described with reference to and illustrated by FIG. 3. Furthermore, in some embodiments, HMI 400 may include a computer storing an executable program that generates signals to automatically adjust these flowrates 500, 600, 700, 800 in accordance with instructions defined within the stored program. The computer program is stored in non-volatile storage, e.g., a hard disk drive, volatile memory, e.g., random access memory, or combinations thereof. The instructions may be either a supplement to or replacement of input provided by an operator.

While various preferred embodiments have been shown and described, modifications thereof can be made by one skilled in the art without departing from the spirit and teachings herein. The embodiments herein are exemplary only, and are not limiting. Many variations and modifications of the apparatus disclosed herein are possible and within the scope of the invention. Accordingly, the scope of protection is not limited by the description set out above, but is only limited by the claims which follow, that scope including all equivalents of the subject matter of the claims.

What is claimed is:

1. A system for de-watering waste drilling fluid, the system comprising:
a manifold comprising:
a de-stabilizing zone adapted to combine organic coagulant and the waste drilling fluid, whereby solids suspended in the waste drilling fluid are de-stabilized and a de-stabilized mixture of the de-stabilized solids is formed; and
an aggregating zone downstream of the de-stabilizing zone, the aggregating zone adapted to combine organic flocculant and the de-stabilized mixture, whereby the de-stabilized solids are aggregated to form a plurality of flocs and an aggregated mixture of the flocs and water is formed.

2. The system of claim 1, wherein the organic coagulant is in at least one of powder, emulsion, and liquid form.

3. The system of claim 2, wherein the organic coagulant is a polyamide coagulant.

4. The system of claim 1, wherein the organic flocculant is in at least one of powder, emulsion, and liquid form.

5. The system of claim 4, wherein the organic flocculant is a blended polyacrylamide flocculant.

6. The system of claim 1, further comprising a centrifuge adaptive to receive the aggregated mixture and separate the flocs from the water to form solid drilling fluid waste and substantially colloidal-free water.

7. The system of claim 6, further comprising at least one of a screen shaker, a desander and desilter hydrocyclone, and a decanter centrifuge.

8. A system for de-watering waste drilling fluid, the system comprising:
a drilling fluid reclamation system receiving the waste drilling fluid from a wellbore and removing at least some solids from the waste drilling fluid;
a manifold combining the waste drilling fluid from the drilling fluid reclamation system and organic polymers, whereby an aggregated mixture of solids in the waste drilling fluid and water are formed; and
a centrifuge receiving the aggregated mixture and separating the solids from the water in the aggregated mixture, whereby solid drilling fluid waste and substantially colloidal-free water are formed.

9. The system of claim 8, wherein the drilling fluid reclamation system comprises:
a screen shaker;
a desander and desilter hydrocyclone; and
a decanter centrifuge.

10. The system of claim 9, wherein the screen shaker is configured to remove solids having a first minimum dimension, the hydrocyclone is configured to remove solids having a second minimum dimension less than the first minimum dimension, and the decanter centrifuge is configured to remove solids having a third minimum dimension less than the first and the second minimum dimensions.

11. The system of claim 8, wherein the manifold comprises:
a de-stabilizing zone adapted to combine organic coagulant and the waste drilling fluid, whereby solids suspended in the waste drilling fluid are de-stabilized and a de-stabilized mixture of the de-stabilized solids is formed; and
an aggregating zone downstream of the de-stabilizing zone, the aggregating zone adapted to combine organic flocculant and the de-stabilized mixture, whereby the de-stabilized solids are aggregated to form a plurality of flocs, whereby the aggregated mixture is formed, wherein the aggregated mixture includes the flocs and the water.

12. The system of claim 11, wherein the organic coagulant is in at least one of powder, emulsion, and liquid form.

13. The system of claim 12, wherein the organic coagulant is a polyamide coagulant.

14. The system of claim 11, wherein the organic flocculant is in at least one of powder, emulsion, and liquid form.

15. The system of claim 14, wherein the organic flocculant is a blended polyacrylamide flocculant.

16. The system of claim 8, further comprising a storage tank receiving the waste drilling fluid from the drilling fluid reclamation system and supplying the waste drilling fluid to the manifold.

17. A method for de-watering of waste drilling fluid flowing at a preselected flowrate, the method comprising:
rotating a sample of the waste drilling fluid in a container to form a vortex;
adding a quantity of organic coagulant to the sample until coagulation of the sample occurs, wherein solids contained in the sample are de-stabilized;
adding a quantity of organic flocculant to the sample until aggregation occurs, wherein a plurality of flocs are formed;
calculating a flowrate of the coagulant as a function of the quantity of the coagulant added to the container, the quantity of the waste drilling fluid added to the container, and the preselected waste drilling fluid flowrate; and
calculating a flowrate of the flocculant as a function of the quantity of the flocculant added to the container, the quantity of the waste drilling fluid added to the container, and the preselected waste drilling fluid flowrate.

18. The method of claim 17, further comprising:
conveying waste drilling fluid at the preselected flowrate through a manifold having a de-stabilizing zone and an aggregating zone;
adding the coagulant at the calculated flowrate to the waste drilling fluid in the de-stabilizing zone, wherein solids suspended in the waste drilling fluid are de-stabilized and a de-stabilized mixture of the de-stabilized solids is formed; and
adding the flocculant at the calculated flowrate to the de-stabilized mixture in the aggregating zone, wherein the de-stabilized solids are aggregated to form a plurality of flocs and an aggregated mixture of the flocs and water is formed.

19. The method of claim 18, further comprising:
separating the flocs and the water in a centrifuge, wherein solid drilling fluid waste and substantially colloidal-free water are formed.

20. The method of claim 18, further comprising:
separating solids from the waste drilling fluid using at least one of a screen shaker, a desander and desilter hydrocyclone, and a decanter centrifuge.
